(19) United States
(12) Patent Application Publication
(10) Pub. No.: US 2021/0008703 A1
(43) Pub. Date: Jan. 14, 2021

(54) STAPLE GUN

(71) Applicant: APEX MFG. CO., LTD., Taichung City (TW)

(72) Inventor: Jing-Li WANG, Taichung City (TW)

(21) Appl. No.: 16/505,167

(22) Filed: Jul. 8, 2019

(51) Int. Cl. B25C 5/11

(52) U.S. Cl. CPC B25C 5/11; B25C 5/06

(57) ABSTRACT

A staple gun includes a housing, a striking member, a driving mechanism and a locking mechanism. The housing includes a staple outlet. The striking member is disposed on the housing. The driving mechanism includes a pressure bar which is rotatably assembled with the housing. The locking mechanism includes a locking member. The locking member is assembled with the housing and is rotatable about an axial direction to be in a locking position or a releasing position. The locking member has a stopping bump formed radially.

### BACKGROUND OF THE INVENTION

### Field of the Invention

The present invention relates to a staple gun.

### Description of the Prior Art

A staple gun includes an elastic plate, a lever and a striker which are disposed on a housing. The striker is connected with the elastic plate and lever. When the lever is pressed, the lever will drive the elastic plate to accumulated force for driving the striker. When the lever is pressed to be in a releasing position, the striker is disengaged from the lever, and the striker is driven by the elastic plate to strike the staple. To avoid unexpected striking of the staple, a swingable limiting member is disposed on an end of the staple gun away from the staple outlet. The lever is pressed to approach the housing and then locked. US20180215025 discloses this kind of staple gun.

However, since the limiting member is exposed outside the housing, the limit member is easy to be unlocked, damaged or detached. To lock the lever, it has to strike the staple one time so that the lever can reach the locking position. To unlock the lever, it needs a hand to press the lever and the other hand has to release the limiting member from the lever, thus being inconvenient. In addition, the staple gun with the limiting member has a complicated structure and is not aesthetic.

The present invention is, therefore, arisen to obviate or at least mitigate the above-mentioned disadvantages.

### SUMMARY OF THE INVENTION

The main object of the present invention is to provide a staple gun having two kinds of locking, in which unexpected striking of the staple can be avoided and the staple gun can be quickly unlocked.

To achieve the above and other objects, the present invention provides a staple gun, including: a housing, including a staple outlet; a striking member, disposed on the housing and being movable toward or away from the staple outlet; a driving mechanism, including a lever rotatably connected to the housing, the lever being swingable between a first position and a second position, the driving mechanism driving the striking member to move toward the staple outlet when the lever swings from the first position toward the second position; a locking mechanism, including a locking member, the locking member disposed on the housing and rotatable about an axial direction between a releasing position and a locking position, the locking member including a stopping bump which protrudes radially and is located inside the housing; wherein when the locking mechanism is in the releasing position, the locking mechanism is free of inference with the lever, and the lever is freely rotatable between the first position and the second position; when the lever swings toward the second position and the locking member rotates to be in the locking position, the stopping bump is abutted against a part of the lever which is located inside the housing so that the lever is stopped by the stopping bump and non-movable toward the first position.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is a drawing showing a part of a staple gun according to a preferable embodiment of the present invention;

FIG. 3 is a partial breakdown drawing of a preferable embodiment of the present invention;

FIG. 4 is a drawing showing a locking member according to a preferable embodiment of the present invention;

FIG. 5 is a side view of FIG. 4;

FIG. 6 is a cross-sectional view of a preferable embodiment of the present invention; and

FIGS. 7 to 10 are drawings showing operation of a staple gun according to a preferable embodiment of the present invention.

### DETAILED DESCRIPTION OF THE PREFERRED EMBODIMENTS

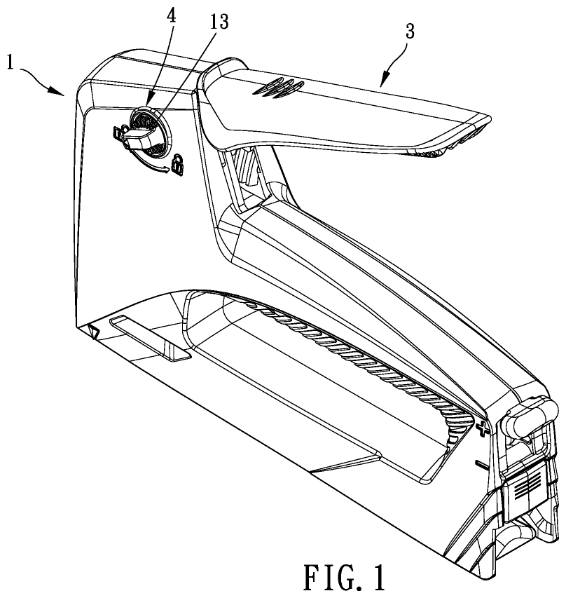

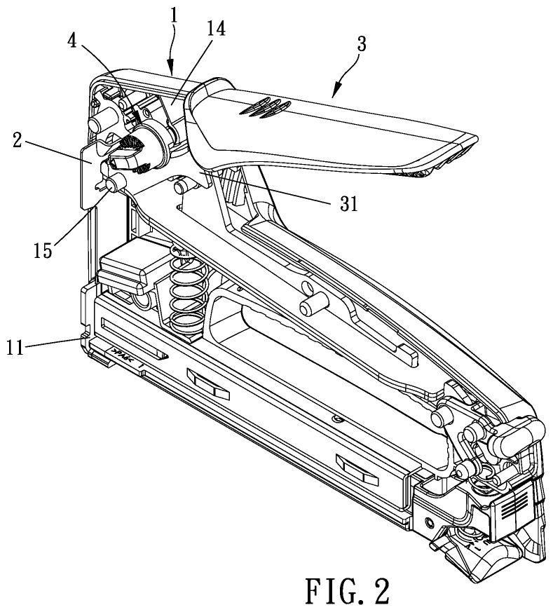

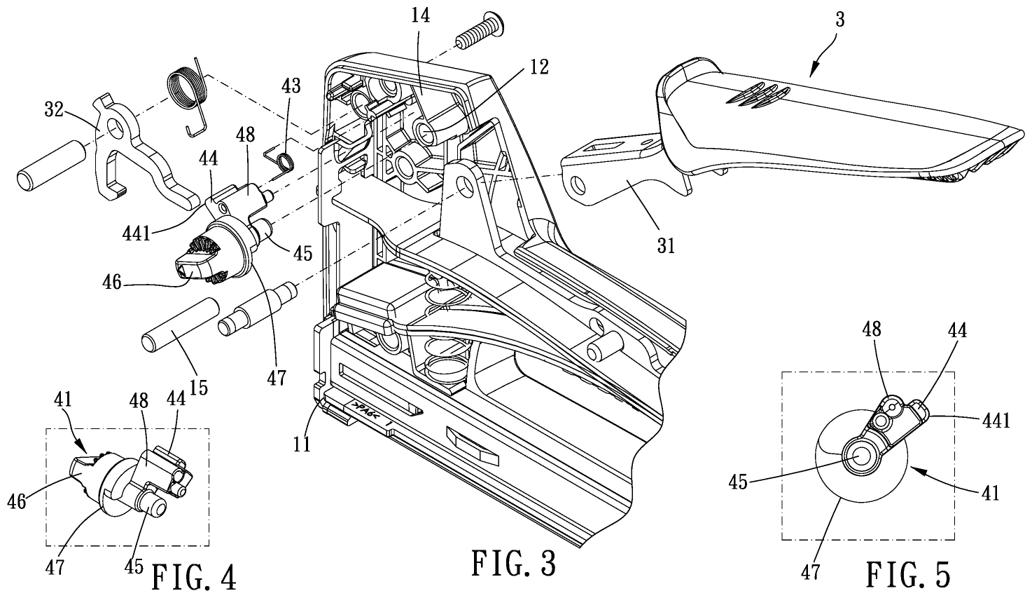

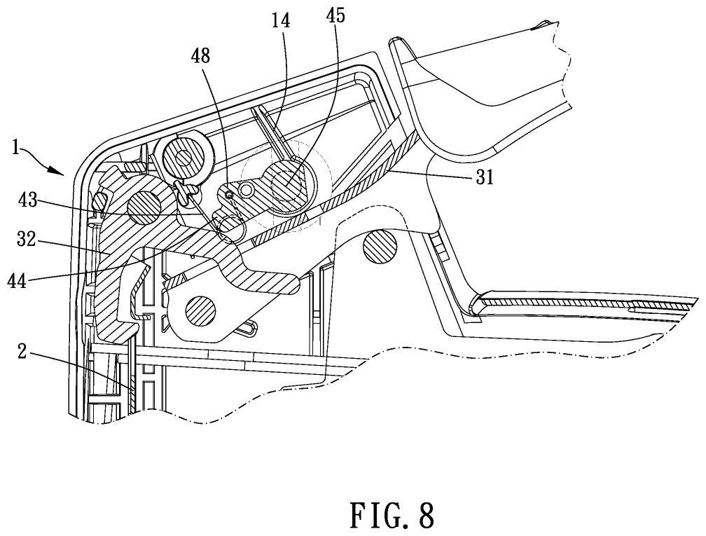

Please refer to FIGS. 1 to 10 for a preferable embodiment of the present invention. A staple gun includes a housing 1, a striking member 2, a driving mechanism 3 and a locking mechanism 4.

The housing 1 includes a staple outlet 11.

The striking member 2 is disposed on the housing 1 and being movable toward or away from the staple outlet 11 movable.

The driving mechanism 3 includes a lever 31 rotatably connected to the housing 1, the lever 31 is swingable between a first position and a second position, and the driving mechanism 3 drives the striking member 2 to move toward the staple outlet 11 when the lever 31 swings from the first position swings toward the second position. In this embodiment, the driving mechanism 3 further includes a retaining member 32 rotatably connected to the housing 1. When the lever 31 is in the first position, the retaining member 32 and the striking member 2 are positionably engaged with each other so that the elastic plate of the staple gun accumulates force; when the lever 31 move to the second position, the retaining member 32 is driven by the lever 31 to disengage from the striking member 2 so that the striking member 2 is movable toward the staple outlet 11 to strike the staple at the staple outlet 11.

The locking mechanism 4 includes a locking member 41, the locking member 41 is disposed on the housing 1 and rotatable about an axial direction between a releasing position and a locking position, and the locking member 41 includes a stopping bump 44 which protrudes radially and is located inside the housing 1.

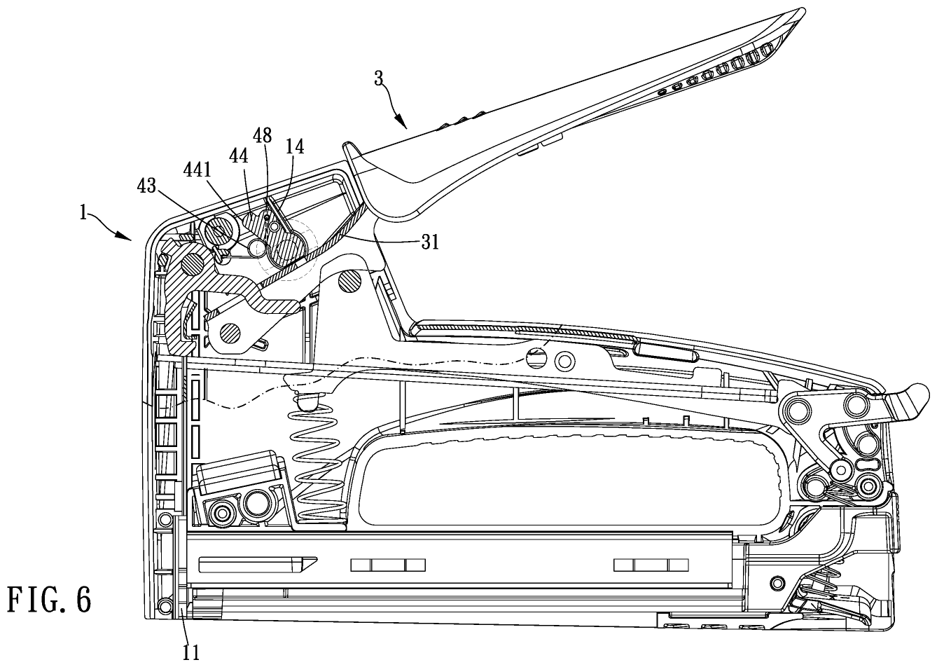

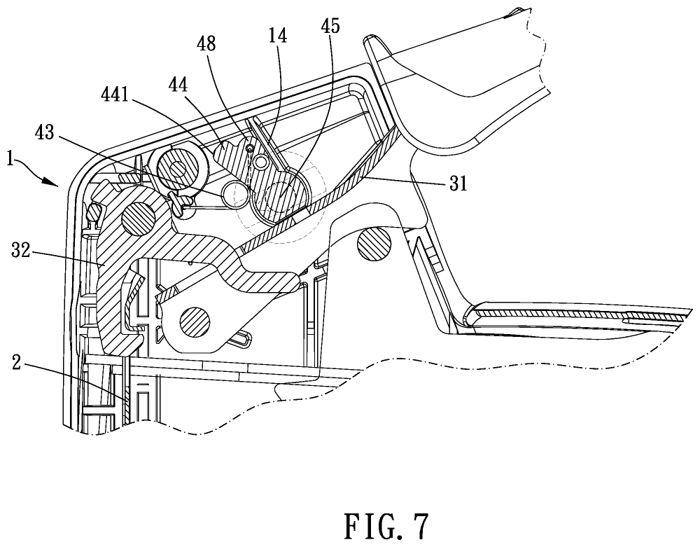

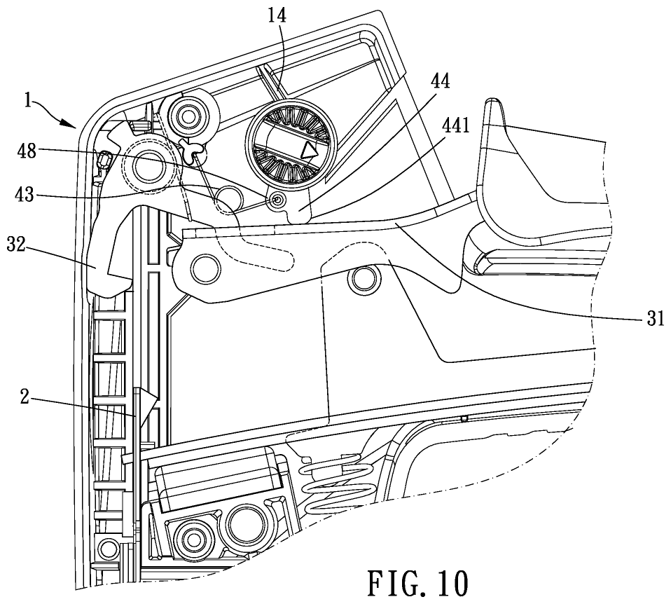

When the locking mechanism 4 is in the releasing position (as shown in FIGS. 6 and 7), the locking mechanism 4 is free of inference with the lever 31, and the lever 31 is freely rotatable between the first position and the second position; when the lever 31 swings toward the second position and the locking member 41 rotates to be in the locking position, the stopping bump 44 is abutted against a part of the lever 31 which is located inside the housing 1 (as shown in FIG. 10) so that the lever 31 is stopped by the stopping bump 44 and non-movable toward the first position and so that the lever 31 is locked, thus compacting the staple gun for easy storage. In this embodiment, the lever 31 and the housing 1 are pivotally connected by a pivot portion 15, and the stopping bump 44 is abutted against a side of the lever 31 away from the staple outlet 11 and is near the pivot portion 15 so that the stopping bump 44 is not exposed to the outside of the housing 1, thus preventing the lever 31 from being unexpectedly unlocked due to external collision.

To unlock the lever 31, it needs only to press the lever 31 toward the second position for a certain distance and the stopping bump 44 is disengaged from the lever 31, and the lever 31 is unlocked. Preferably, the stopping bump 44 includes an arcuate corner 441 facing the locking position, for easy disengagement of the stopping bump 44 from the lever 31 so that the locking member 41 can return to the releasing position and the lever 31 can return to the first position, thus being easy to use.

Specifically, the locking member 41 further includes a shaft 45 located inside the housing, and the shaft 45 is rotatably inserted into a shaft hole 12 of the housing 1. The locking member 41 further includes an operative portion 46, and the operative portion 46 projects outwardly beyond and outside the housing 1, for easy operation.

The locking member 41 further includes an annular flange 47 integrally and radially extending between the operative portion 46 and the shaft 45, the housing 1 further includes a receiving hole 13, the annular flange 47 is abutted against an inner periphery of the receiving hole 13 inside the housing 1.

The locking mechanism further includes an elastic member 43, and the elastic member 43 is abutted against and between the housing 1 and the locking member 41 so that the locking member 41 has a tendency to rotate. Specifically, the locking member 41 further includes an extending portion 48 radially extending between the annular flange 47 and the shaft 45, and the stopping bump 44 is connected with the extending portion 48, so that the stopping bump 44 has good structural strength. A radial extent of the stopping bump 44 is larger than a radial extent of the extending portion 48, for effective abutment against the lever 31. Preferably, the shaft 45, the operative portion 46, the annular flange 47, the extending portion 48 and the stopping bump 44 are integrally formed of one piece, thus being easy to manufacture and having good structural strength.

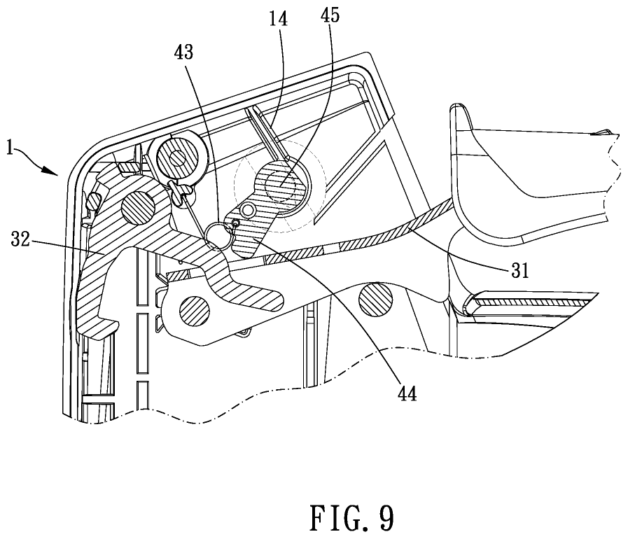

In this embodiment, the elastic member 43 is a torsion spring, one end of the elastic member 43 is inserted into the extending portion 48, and another end of the elastic member 43 is inserted to the housing 1. As viewed in the axial direction, when the one end of the elastic member 43 inserted into the extending portion 48 is higher than an extending line from the another end of the elastic member 43 to the shaft 45 (as shown in FIG. 7), and the locking member 41 has a tendency to rotate toward the releasing position; when the lever 31 moves to the second position, the locking member 41 has to be rotated toward the locking position to make the stopping bump 44 abut against the lever 31, for facilitating striking the staple; when the elastic member 43 inserted into the extending portion 48 is lower than the extending line from the another end of the elastic member 43 to the shaft 45, the locking member 41 has a tendency to rotate toward the locking position (as shown in FIG. 9), and the stopping bump 44 of the locking member 41 can drive the retaining member 32 so that the retaining member 32 is disengaged from the striking member 2; when the lever 31 is press to move to the second position, the stopping bump 44 swings toward the locking position so that the stopping bump 44 is abutted against the lever 31 and the staple cannot be stricken, thus being safe. It is noted that the elastic member may bias the locking member 41 toward the releasing position.

In this embodiment, the housing 1 further includes a blocking portion 14, and when the locking member 41 returns to the releasing position, the extending portion 48 is positionably blocked by the blocking portion 14.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A staple gun, including:
a housing, including a staple outlet;
a striking member, disposed on the housing and being movable toward or away from the staple outlet;
a driving mechanism, including a lever rotatably connected to the housing, the lever being swingable between a first position and a second position, the driving mechanism driving the striking member to move toward the staple outlet when the lever swings from the first position toward the second position;
a locking mechanism, including a locking member, the locking member disposed on the housing and rotatable about an axial direction between a releasing position and a locking position, the locking member including a stopping bump which protrudes radially and is located inside the housing;
wherein when the locking mechanism is in the releasing position, the locking mechanism is free of inference with the lever, and the lever is freely rotatable between the first position and the second position; when the lever swings toward the second position and the locking member rotates to be in the locking position, the stopping bump is abutted against a part of the lever which is located inside the housing so that the lever is stopped by the stopping bump and non-movable toward the first position.

2. The staple gun of claim 1, wherein the locking member further includes a shaft located inside the housing, the shaft is rotatably inserted into a shaft hole of the housing, the locking member further includes an operative portion, and the operative portion projects outwardly beyond and outside the housing.

3. The staple gun of claim 2, wherein the locking member further includes an annular flange integrally and radially extending between the operative portion and the shaft, the housing further includes a receiving hole, and the annular flange is abutted against an inner periphery of the receiving hole inside the housing.

4. The staple gun of claim 3, wherein the locking mechanism further includes an elastic member, and the elastic member is abutted against and between the housing and the locking member so that the locking member has a tendency to rotate.

5. The staple gun of claim 4, wherein the locking member further includes an extending portion radially extending between the annular flange and the shaft, the stopping bump is connected with the extending portion, a radial extent of the stopping bump is larger than a radial extent of the extending portion, and the shaft, the operative portion, the annular flange, the extending portion and the stopping bump are integrally formed of one piece.

6. The staple gun of claim 5, wherein the elastic member is a torsion spring, one end of the elastic member is inserted into the extending portion, another end of the elastic member is inserted to the housing; as viewed in the axial direction, when the one end of the elastic member inserted into the extending portion is higher than an extending line from the another end of the elastic member to the shaft, the locking member has a tendency to rotate toward the releasing position; when the one end of the elastic member inserted into the extending portion is lower than the extending line from the another end of the elastic member to the shaft, the locking member has a tendency to rotate toward the locking position.

7. The staple gun of claim 6, wherein the housing further includes a blocking portion, and when the locking member returns to the releasing position, the extending portion is positionably blocked by the blocking portion.

8. The staple gun of claim 1, wherein the stopping bump includes an arcuate corner facing the locking position.

9. The staple gun of claim 1, wherein the lever and the housing are pivotally connected by a pivot portion, and the stopping bump is abutted against a side of the lever away from the staple outlet and is near the pivot portion.

10. The staple gun of claim 1, wherein the driving mechanism further includes a retaining member rotatably connected to the housing, when the lever is in the first position, the retaining member and the striking member are positionably engaged with each other; when the lever move to the second position, the retaining member is driven by the lever to disengage from the striking member so that the striking member is movable toward the staple outlet.
